(19) United States
(12) Patent Application Publication
(10) Pub. No.: US 2004/0028970 A1
(43) Pub. Date: Feb. 12, 2004

(54) Fuel cell system and method

(76) Inventors: Hiromasa Sakai, Kanagawa (JP); Yasukazu Iwasaki, Kanagawa (JP)

Correspondence Address: FOLEY AND LARDNER, SUITE 500, 3000 K STREET NW, WASHINGTON, DC, 20007, US

(21) Appl. No.: 10/416,528

(22) PCT Filed: Sep. 12, 2002
(86) PCT No.: PCT/JP02/09344

(30) Foreign Application Priority Data
Oct. 2, 2001 (JP) 2001-306237

(51) Int. Cl. H01M 8/04

(52) U.S. Cl. 429/24; 429/22; 429/13; 429/26

(57) ABSTRACT

A fuel cell system includes a fuel cell (29) supplied with gas including hydrogen and gas including oxygen, a humidifying mechanism (73, 31) humidifying either one of the gas including the hydrogen and the gas including the oxygen or both of such gases using water from a water tank (19), a water collection mechanism (73, 31) collecting water from the fuel cell to return the water collected with the water collection mechanism to the water tank, an atmospheric temperature sensor (69) sensing an atmospheric temperature, and a controller (57) performing a high temperature control to increase an exhaust including steam to be expelled outside the fuel cell system when the atmospheric temperature sensed by the atmospheric temperature sensor exceeds a given temperature.

### TECHNICAL FIELD

The present invention relates to a fuel cell system and a method and, more particularly, to a fuel cell system and a method that enable water to be collected for reuse from exhausts expelled from a fuel cell.

### BACKGROUND ART

In fuel cell systems for vehicles such as electric automobiles, it has been proposed to provide a structure for collecting product water and humidifying water for reuse from exhausts of a fuel cell.

Japanese Patent Application Laid-Open Publication No. 2001-23678 discloses a fuel cell system. Such a fuel cell system includes a condenser that collects water from exhaust gases expelled from a fuel cell, a water tank that stores collected water, and a reformer that reforms methanol using water from the water tank. With such a structure, an equilibrium operating pressure, which causes a water balance to fall in equilibrium within the fuel cell system, is calculated in dependence on the temperature of the exhausts expelled from the condenser, allowing the fuel cell to operate under an operating pressure in a range above such an equilibrium operating pressure.

Japanese Patent Application Laid-Open Publication No. H5-74477 discloses a power output limit device for a fuel cell power generation plant. Such an output limit device of the fuel cell power generation plant includes a cooling tower serving as an exhaust heat removal unit, with an atmospheric temperature at an air inlet of the cooling tower being detected. A power output upper limit value function generator calculates a power output upper limit value from the atmospheric temperature. The power output upper limit value corresponds to a heat quantity that causes an excessive heat produced in the fuel cell power generation plant and the maximum heat radiation performance of the cooling tower to be equalized.

Japanese Patent Application Laid-Open Publication No. H8-250130 discloses a fuel cell equipped with a porous type bipolar plate.

### DISCLOSURE OF INVENTION

However, considerable research and development work undertaken by the present inventors has revealed that with the fuel cell system disclosed in Japanese Patent Application Laid-Open Publication No. 2001-23678, an extremely large heat radiation must be achieved in order to obtain a large amount of power output while ensuring the equilibrium operating pressure at all times so as to maintain the water balance in the equilibrium condition. Specifically, taking the situation with the atmospheric temperature remaining at the high level into consideration, the radiator has an inability of having a temperature difference between air and water and, hence, the radiator having a large radiation heat coefficient must be prepared, resulting in an increase in volume and weight of the cooling system.

That is to say, when applying the fuel cell system to the vehicle in which structural components parts are limited in size, a difficulty is encountered in preparing a layout to successfully encompass such a largely sized cooling system within the vehicle. In such a case, however, if attempts for effectively collecting water with the cooling system remained to have a small capacity are abandoned, the operating pressure of the fuel cell system must be lowered, with a resultant inherent risk of severe situations in which the vehicle has to continue its traveling while replenishing pure water which has an extremely low electric conductivity and has a poor availability. And, with the cooling system having the small capacity, if the fuel cell system is forced to operate for producing a high power output when the atmospheric temperature is at a high level, the temperature of the fuel cell unavoidably increases toward an excessively high level beyond an allowable limit.

Further, the power output limit device of the fuel cell power generation plant, disclosed in Japanese Patent Application Laid-Open Publication No. H5-74477, is structured to limit the power output of the fuel cell power generation plant when the atmospheric temperature exceeds a given level in which an effective heat radiation becomes difficult to achieve. If such a structure is applied to the vehicle, it is conceivable that in a midsummer, there is a need for the maximum power output of the fuel cell to be limited at all times, resulting in deterioration in a power performance of the vehicle which leads to an inability to meet requirements such as rapid acceleration.

The present invention has been completed upon the studies set forth above and has an object to provide a fuel cell system and a method which has no need for supplying pure water while limiting an increase in size and weight of a cooling system to provide an abundant applicability to a vehicle and which is able to meet requirements for rapid acceleration without limitation in power output of a fuel cell even at a high atmospheric temperature, practically.

To achieve the above object, according to one aspect of the present invention, a fuel cell system comprises: a fuel cell supplied with gas including hydrogen and gas including oxygen; a humidifying mechanism humidifying either one or both of the gas including the hydrogen and the gas including the oxygen using water from a water tank; a water collection mechanism collecting water from the fuel cell, the water collected by the water collection mechanism being returned to the water tank; an atmospheric temperature sensor sensing an atmospheric temperature; and a controller performing a high temperature control to increase an exhaust including steam to be expelled outside the fuel cell system when the atmospheric temperature sensed by the atmospheric temperature sensor exceeds a given temperature.

Stated another way, a fuel cell system comprises: a fuel cell supplied with gas including hydrogen and gas including oxygen; humidifying means for humidifying either one or both of the gas including the hydrogen and the gas including the oxygen using water from a water tank; water collection means for collecting water from the fuel cell, the water collected by the water collection means being returned to the water tank; atmospheric temperature sensing means for sensing an atmospheric temperature; and control means for performing a high temperature control to increase an exhaust including steam to be expelled outside the fuel cell system when the atmospheric temperature sensed by the atmospheric temperature detection means exceeds a given temperature.

In the meantime, according to another aspect of the present invention, there is provided a method of controlling a fuel cell system, comprising: supplying gas including hydrogen and gas including oxygen to a fuel cell; humidifying either one or both of the gas including the hydrogen and the gas including the oxygen using water from a water tank; collecting water from the fuel cell to circulate the collected water to the water tank; sensing an atmospheric temperature; and performing a high temperature control to increase an exhaust including steam to be expelled outside the fuel cell system when a sensed atmospheric temperature exceeds a given temperature.

Other and further features, advantages, and benefits of the present invention will become more apparent from the following description taken in conjunction with the following drawings.

### BRIEF DESCRIPTION OF DRAWINGS

FIG. 1 is a system structural view illustrating an overall structure of a fuel ell powered automobile installed with a fuel cell system of a first embodiment according to the present invention;

FIG. 2 is a control block diagram of the fuel cell system shown in FIG. 1 of the first embodiment;

FIG. 3 is a view illustrating a map of a target value Pfcl of an operating pressure of a fuel cell in terms of a water tank water level Lw in the fuel cell system shown in FIG. 1 of the first embodiment;

FIG. 4 is a view illustrating a map of a power output upper level value PWlim of the fuel cell in terms of an atmospheric temperature Tatm when the water level remains in a low level in the fuel cell system shown in FIG. 1 of the first embodiment;

FIG. 5 is a view illustrating a radiation heat quantity QR of a radiator in terms of the atmospheric temperature Tatm when the pressure is maintained at a value to establish a water balance in the fuel cell system shown in FIG. 1 of the first embodiment;

FIG. 6 is a view illustrating a map of an upper limit value Pfclim of the operating pressure of the fuel cell, depending on loads, in terms of the atmospheric temperature Tatm when the water level remains at a normal level in the fuel cell system shown in FIG. 1 of the first embodiment;

FIG. 7 is a general flow diagram for illustrating the basic sequence of operations of the fuel cell system shown in FIG. 1 of the first embodiment;

FIG. 8 is a system structural view illustrating an overall structure of a fuel ell powered automobile installed with a fuel cell system of a second embodiment according to the present invention;

FIG. 9 is a general flow diagram for illustrating the basic sequence of operations of the fuel cell system shown in FIG. 8 of the second embodiment;

FIG. 10 is a general flow diagram for illustrating the basic sequence of operations of a fuel cell system of a third embodiment according to the present invention; and

FIG. 11 is a time chart illustrating the basic sequence of the operations shown in FIG. 10 of the third embodiment.

### BEST MODE FOR CARRYING OUT THE INVENTION

To describe the present invention below more in detail, respective embodiments of the present invention will be explained hereinafter with reference to the accompanied drawings. Also, the respective embodiments will be described each in conjunction with an example in which the fuel cell system and a related method thereof are applied to a fuel cell powered automobile.

(First Embodiment)

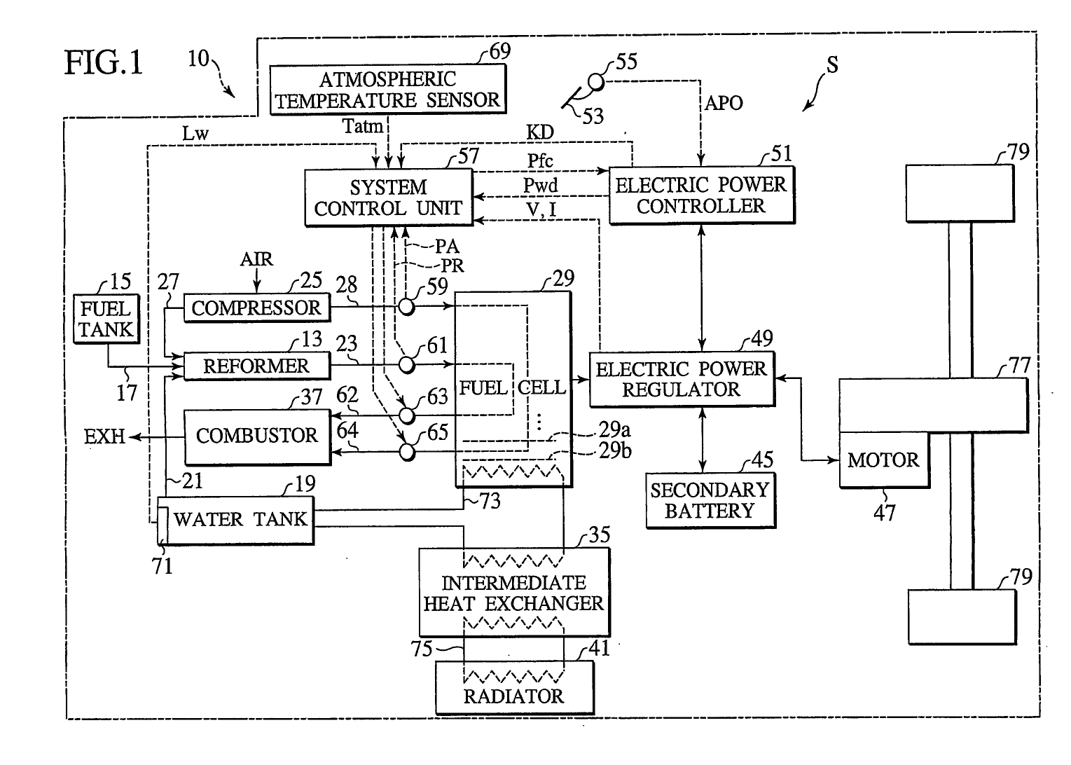

First, a fuel cell system and a related method thereof of a first embodiment according to the present invention is described in detail with reference to FIGS. 1 to 7.

FIG. 1 is an overall system structural view illustrating an overall structure of a fuel cell powered automobile 10 equipped with a fuel cell system S according to the present invention. Also, a kick down signal KD shown in FIG. 1 is not used in the presently filed embodiment and is used in a third embodiment which will be described below.

In FIG. 1, a reformer 13 performs steam reforming methanol, which forms a fuel that is supplied from a fuel tank 15 via a line 17, using pure water which is supplied from a water tank 19 via a line 21 to produce reformed gas including hydrogen which is then supplied through a line 23 to a fuel cell 29. Also, the reformer 13 may be of the type that produces reformed gas by partial oxidation of air, which is supplied from a compressor 25 via a line 27, and methanol that is supplied from the fuel tank 15 via the line 17. In this connection, it is to be noted that the steam reforming process utilizes endothermic reaction, and the partial oxidation uses exothermic reaction.

Reformed gas supplied from the reformer 13 via the line 23 and air supplied from the compressor 25 via the line 28 are fed to a plurality of pairs of fuel electrodes 29a and air electrodes 29b of the fuel cell 29 (fuel cell stack), respectively, causing electrochemical reaction to take place between hydrogen included in reformed gas and oxygen included in air to generate direct current electric power output. Here, hydrogen included in reformed gas and oxygen included in air are not entirely consumed within the fuel cell 29, and these gases are fed to a combustor 37 via pressure adjusting valves 63, 65, respectively, with portions of these gases remaining in the fuel cell 29. Also, gas to be supplied to the air electrode 29b does not necessarily include air, but may suffice to include gas including oxygen.

The combustor 37 serves to combust hydrogen remaining in reformed gas with oxygen remaining in air. Also, combustion reaction heat produced in the combustor 37 is effective to evaporate methanol and pure water in the reformer 13 and, hence, is used as a heat source for endothermic reaction to perform steam reforming, with residual exhaust gases being emitted outside.

Pure water stored in the water tank 19 circulates in such a manner that it is introduced as coolant water to the fuel cell 29 via a pure water channel 73 disposed adjacent the respective air electrodes 29b from which pure water is then introduced to an intermediate heat exchanger 35 and subsequently returned to the water tank 19. When this occurs, water is exchanged between either one of reformed gas and air supplied to the fuel cell 29 or both of the reformed gas and air supplied to the fuel cell 29 and coolant water via corresponding porous bipolar plates (not shown). That is, the pure water channel 73 is effective not only to supply coolant water for cooling the fuel cell 29 but also to function as a humidifying mechanism for humidifying supply gases while serving as a water collecting mechanism that enables portions of product water, produced through electrochemical reaction of hydrogen and oxygen in the fuel cell 29, and water used for humidifying purposes to be collected into coolant water.

Here, the intermediate heat exchanger 35 takes the form of a heat exchanger that performs heat exchange between pure water in the pure water channel 73 and LLC in an LLC channel 75. The LLC channel 75 serves to circulate LLC (long life coolant: anti freeze solution) between the intermediate heat exchanger 35 and a radiator 41, causing heat robbed from pure water in the intermediate heat exchanger 35 to be discharged outside via the radiator 41. Also, the coolant line of the fuel cell 29 includes the pure water channel 73 and the LLC channel 75 which are separate from one another with a view to providing an ease of installation of these components to a vehicle such as an automobile and to providing an ease of anti-freezing of the pure water circulation line.

A secondary battery 45 stores electric power output generated by the fuel cell 29 and regenerative power generated by an electric motor 47 during deceleration of the vehicle by means of an electric power regulator 49 while serving to supply electric power output, which is short during start up of the fuel cell system S and during start up acceleration of the vehicle, to various accessories of the fuel cell 29 and the motor 47.

In an event that traveling electric power, to be consumed with the motor 47, and accessory electric power, to be consumed with the accessories such as the compressor 25, the reformer 13 and the combustor 37 can not be covered with electric power output generated by the fuel cell 29, the electric power regulator 49 is operative to distribute electric power output to the motor 47 and the associated accessories from the secondary battery 45 in response to control signals output from an electric power controller 51. Also, the electric power controller 49 is internally provided with a voltage sensor and an electric current sensor for detecting a voltage V and an electric current I, respectively, of the electric power output generated by the fuel cell 29 to deliver detection signals to a system control unit 57.

The electric power controller 51 compels the electric power output to be distributed via the electric power regulator 49 while controlling the amount of electric power output to be supplied to the motor 47 via the electric power regulator 49 in response to an accelerator opening signal APO indicative of the amount of incremental displacement of an accelerator pedal 53 detected with an accelerator position sensor 55. Also, output torque of the motor 47 is transferred to tires 79, 79 of respective drive wheels via a gear reduction unit 77 having a gear reduction and differential gear function, causing the fuel cell powered automotive 10 to be driven.

A pressure sensor 59 is disposed in a line 28 to detect pressure PA of air to be supplied to the fuel cell 29 from the compressor 25 for producing a detection signal, indicative of such an air pressure level, which is applied to the system control unit 57. Further, a pressure sensor 61 is disposed in a line 23 to detect pressure PR of reformed gas to be supplied to the fuel cell 29 from the reformer 13 for producing a detection signal, indicative of such a reformed gas pressure level, which is applied to the system control unit 57.

The pressure adjusting valve 63 is disposed in a line 62 between the fuel cell 29 and the combustor 37 to adjust pressure of exhaust reformed gas to be fed to the combustor 37 from the fuel cell 29. Also, the pressure adjusting valve 65 is disposed in a line 64 between the fuel cell 29 and the combustor 37 to adjust pressure of exhaust air to be fed to the combustor 37 from the fuel cell 29.

An atmospheric temperature sensor 69 detects the temperature Tatm of an atmosphere to produce an atmospheric temperature signal that is delivered to the system control unit 57.

A water level sensor 71 is disposed in the water tank 19 to detect a level Lw of pure water stored therein to produce a water tank water level signal that is delivered to the system control unit 57.

The system control unit 57 monitors the air pressure level detected with the pressure sensor 59 and the reformed gas pressure signal detected with the pressure sensor 61 for adjusting the opening degrees of the pressure adjusting valves 63, 65, resulting in control of an operating pressure of the fuel cell 29. Further, the system control unit 57 calculates an operating load of the fuel cell system in dependence on the voltage V and the electric current I detected with the voltage sensor and the electric current sensor, respectively, contained in the power regulator 49.

Furthermore, when the atmospheric temperature sensor 69 detects the presence of the atmospheric temperature equal to or exceeding a given level, the system control unit 57 operates to perform a high temperature control to increase the flow rate of steam to be exhausted outside the fuel ell system according to the atmospheric temperature so as to achieve a control to discharge a large amount of evaporation heat by expelling exhaust, including a large amount of steam, from the fuel cell 29 during the operation at the high temperature.

In the meantime, the higher the gas pressures (which are determined to have values that are substantially equal to one another and which correspond to the operating pressure of the fuel cell 29) of air and reformed gas to be supplied to the fuel cell 29, the larger will be the amount of water to be collected in the fuel cell 29. On the contrary, although the amount of water to be collected decreases as the gas pressures decreases, the amount of reduction in collected water results in steam that is exhausted outside to cause the steam and latent heat included therein to be discharged, thereby decreasing the temperature of the fuel cell 29.

Here, the fuel cell system is structured in that the gas pressures of air 27 and reformed gas 23, which form the supply gases to be applied to the fuel cell 29, are detected with the pressure sensors 59, 61 disposed in the lines 28, 23, respectively, to allow the opening degrees of the pressure adjusting valves 63, 65, disposed in the exhaust hydrogen line 62 and the exhaust air line 64, respectively, of the fuel cell 29 to be controlled, respectively, for thereby controlling the fuel cell 29 at a given operating pressure.

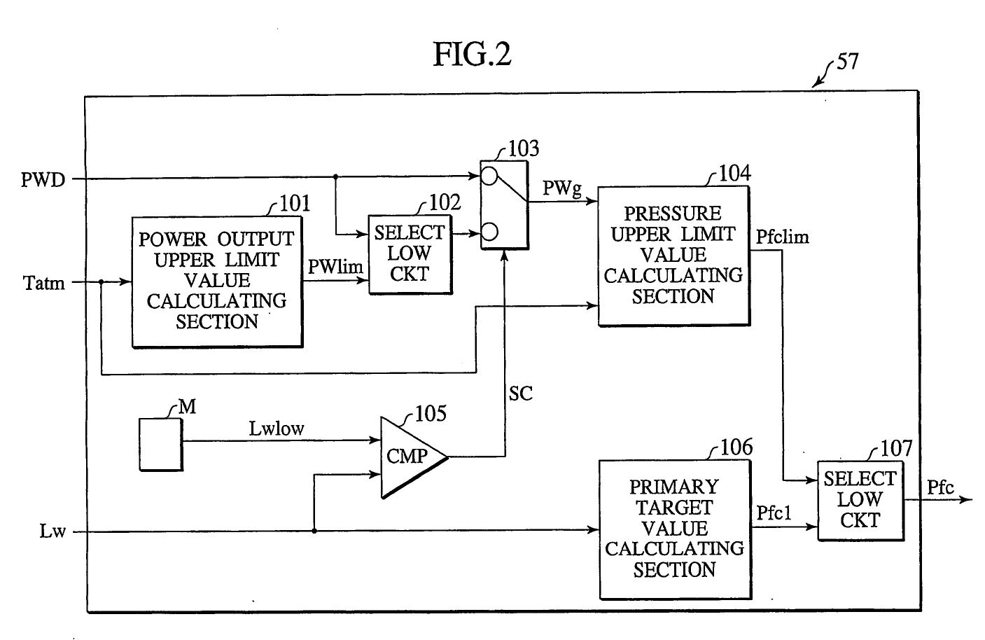

FIG. 2 shows a block diagram of the system control unit 57.

In FIG. 2, the system control unit 57 has a structure to perform control of the operating pressure of the fuel cell 29 and control at the high operating temperature in dependence on the detected value of the atmospheric temperature sensor 69.

In particular, the system control unit 57 includes a power output upper limit calculating section 101, a select-low circuit 102, a switch 103, a pressure upper limit calculating section 104, a comparator 105, a primary target value calculating section 106 and a select-low circuit 107.

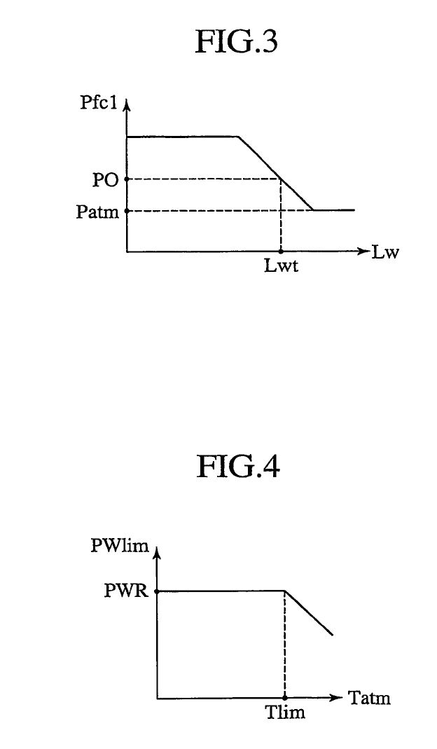

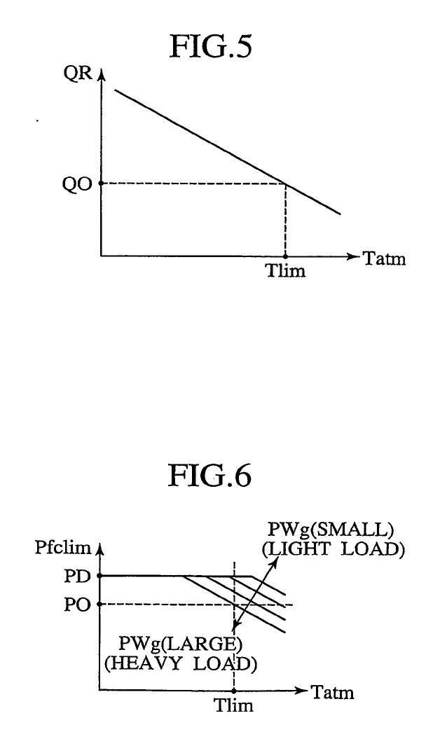

More particularly, the output upper limit calculating section 101 calculates a power output upper limit value PWlim of the fuel cell 29 referring to an atmospheric temperature-power output upper limit value map which stores the power output upper limit value PWlim of the fuel cell 29 in terms of the atmospheric temperature Tatm (as will hereinafter be shown in FIG. 4). The select-low circuit 102 produces either small one of the power output upper limit value PWlim and a demanded power output PWd. The switch 103 serves to switch over between the output of the select-low circuit 102 and the demanded power output PWd, permitting a fuel cell power output PWg to be output. Here, the comparator 105 compares the water tank water level Lw and a water level minimum value Lw stored in a memory M as a given threshold value to cause the switch 103 to select the demanded power output PWd when the water level Lw exceeds the lower limit value Lwlow while delivering a selection signal SC to the switch 103 so as to select the output of the select- low circuit 102 when the water level Lw is below the lower limit value Lwlow. Such a water level low limit value Lwlow represents the water level that corresponds to a minimum volume of water necessary for circulation through the fuel cell 29 in order for the fuel cell 29 to operate without any substantial obstacles. The pressure upper limit value calculating section 104 calculates a pressure upper limit value Pfclim of the fuel cell 29 referring to an atmospheric temperature-pressure upper limit value map (as shown in FIG. 6 which will be described below) which stores the pressure upper limit value Pfclim of the fuel cell 29 in terms of the power output PWg of the fuel cell 29 and the atmospheric temperature Tatm. The primary target value calculating section 106 calculates a primary target value Pfcl of the operating pressure of the fuel cell 29 referring a water tank water level-operating pressure map (as shown in FIG. 3 which will be described below) which stores a primary target value Pfcl of the operating pressure in terms of the water tank water level Lw. And, the select-low circuit 107 selects either small one of the pressure upper limit value Pfclim and the primary target value Pfcl of the operating pressure as an operating pressure control target value Pfc.

Accordingly, the system control unit 57 is operative to control the operating pressure of the fuel cell 29 through respective controls of opening degrees of the pressure adjusting valves 63, 65, disposed in the exhaust hydrogen line 62 and the exhaust air line 64, in response to the operating pressure control target value Pfc obtained in such a manner set forth above.

Also, the fuel cell power output PWg is delivered to the electric power controller 51, which is responsive to the fuel cell power output PWg for distributing the electric power output via the electric power regulator 49.

FIG. 3 shows the water tank water level-operating pressure map which stores the primary target value Pfcl of the operating pressure in terms of the water tank water level Lw. Such a map is designed to determine the primary target value Pfcl of the operating pressure of the fuel cell 29 in dependence on the water level Lw of the water tank 19 whereby the lower the water level of the water tank 19, the higher will be the operating pressure of the fuel cell 29 to increase the amount of collected water. On the other hand, the higher the water level of the water tank 19, the lower the operating pressure of the fuel cell 29, with a resultant decrease in the load of the compressor 25 for providing an improved efficiency in the fuel cell system. Also, in a normal practice, the operating pressure PO of the fuel cell 29 is determined such that a collected water balance is established at a target water level Lwt of the water tank 19 which is preliminarily specified in terms of the primary target value Pfcl of the operating pressure of the fuel cell 29, causing the water balance to be established at a value close proximity to the target water level Lwt. Also, in the figures, the atmospheric pressure is represented at Patm.

FIG. 4 shows the atmospheric temperature-power output upper limit value map that stores the power output upper limit value PWlim of the fuel cell 29 in terms of the atmospheric temperature Tatm. Such a map is designed to determine a power output limit value, i.e. the power output upper limit value Pwlim of the fuel cell 29 at the operating pressure PO of the fuel cell 29 that does not cause the water balance to be in short and to be minus, in terms of the atmospheric temperature Tatm. Here, the rated power output of the fuel cell 29 is represented at PWR, and a limit value of the atmospheric temperature Tatm, which enables the rated power output PWR to be produced upon establishment of the water balance of the water tank 19 to prevent water from being reduced in volume, is indicated at Tlim. If the atmospheric temperature exceeds the limit value of Tlim, the power output limit value Pwlim is decreased to a lower value than the rated power output PWR. Also, the radiation heat quantity QR of the radiator 41 is plotted in terms of the atmospheric temperature Tatm in FIG. 5. As shown in FIG. 5, the limit value of the atmospheric temperature Tatm, which enables the rated power output PWR to be produced upon establishment of the water balance of the water tank 19 to prevent water from being reduced in volume, is indicated at Tlim, and the radiation heat quantity of the radiator 41 corresponding to such rated power output PWR is indicated at QO.

FIG. 6 shows the atmospheric temperature-pressure upper limit value map that stores the pressure upper limit value Pfclim, which corresponds to the operating pressure upper limit of the fuel cell 29, in terms of the power output (operating load) PWg of the fuel cell 29 and the atmospheric temperature Tatm. In such a map, the pressure upper limit value Pfclim of the fuel cell 29 is determined such that the higher the atmospheric temperature Tatm, the lower the pressure upper limit value, and the larger the power output (operating load) PWg of the fuel cell 29, the lower the upper the pressure upper limit value. Also, in the figure, the limit value of the atmospheric temperature Tatm, which enables the rated power output PWR to be produced upon establishment of the water balance of the water tank 19 to prevent water from being reduced in volume, is indicated at Tlim, and the operating pressure of the fuel cell 29, which does not cause the water balance to be in short and to be minus, is indicated at PO, with the upper limit of the operating pressure to be considered in design of the hardware of the fuel cell 29 being indicated at PD.

Also, various maps to be used in the system control unit 57 are adopted from among those preliminarily stored in memories (not shown) internally incorporated in the system control unit 57.

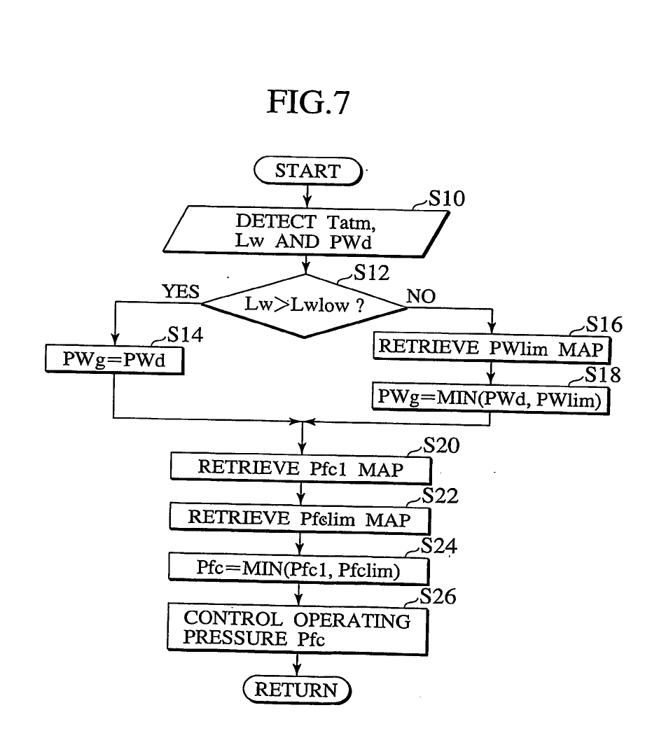

Now, operation of the presently filed embodiment is described with reference to FIG. 7 that shows a general flow diagram for illustrating the basic sequence of operations for controlling the fuel cell 29 using the system control unit 57. Also, it is to be noted that such control is carried out with the system control unit 57 for each cycle in a fixed time interval (for instance, 10 ms).

In FIG. 7, at the start in step S10, the system control unit 57 detects the atmospheric temperature Tatm, the water tank water level Lw and the demanded power output PWd, respectively. Here, the demanded power output PWd represents the power output of the fuel cell 29 demanded by the automobile and is calculated with the electric power controller 51 in dependence on the acceleration requirement represented by the acceleration opening signal APO and a state of charge (SOC) of the secondary battery 45, with the demanded power output PWd being subsequently delivered to the system control unit 57.

In the next step S12, the water level Lw of the water tank 19 and the given lower limit value Lwlow are compared using the comparator 105, discriminating whether the water level Lw of the water tank 19 exceeds the lower limit value Lwlow. And, if the water level appears to exceed the given lower limit value Lwlow, the operation proceeds to step S14.

That is, in step S12, if it is discriminated that the water tank water level exceeds the given lower limit value Lwlow, then in step S14, the switch 103 is actuated so as to cause the fuel cell 29 to produce the same amount of power output PWg as that of the demanded power output PWd.

Then in step S20, referring to the map shown in FIG. 3 using the primary target calculating section 106 to enable determination of the operating pressure Pfc of the fuel cell 29 allows the primary target value Pfcl of the operating pressure of the fuel cell 29 to be retrieved in terms of the water tank water level Lw.

In subsequent step S22, referring to the map shown in FIG. 6 using the pressure upper limit calculating section 104 to determine the operating pressure Pfc of the fuel cell 29 allows the pressure upper limit value Pfclim of the fuel cell 29, which thermally falls in an upper limit of the operating pressure, to be retrieved.

In succeeding step S24, either small one of the primary target value Pfcl of the operating pressure of the fuel cell 29 obtained in step S20 and the pressure upper limit value Pfclim of the fuel cell 29, which thermally forms the upper limit, obtained in step S22 is selected using the select-low circuit 107, thereby determining the operating pressure Pfc of the fuel cell. That is, the system control unit 57 serves to determine the pressure upper limit value Pfclim of the fuel cell 29 that forms the thermally upper limit, providing the upper limit value in terms of the primary target value Pfcl determined in step S20. This is because of the fact that the presence of an increase in the operating pressure of the fuel cell 29 to collect water leads to an increase in heat generated by the fuel cell 29 whereupon, if the heat in the fuel cell 29 builds up to a level equal to or beyond the limit of the radiation heat of the radiator 41, the fuel cell 29 undergoes an excessive temperature rise beyond an allowable value. To address this issue in advance, the pressure upper limit value Pfclim is determined not to exceed the radiation heat limit of the radiator 41 and the upper limit is provided to the primary target value Pfcl according to the atmospheric temperature Tatm and the operating load of the fuel cell 29.

In the next step S26, the system control unit 57 serves to adjust the opening degrees of the pressure adjusting valves 63, 65, rendering the fuel cell system to be operative at the operating pressure Pfc of the fuel cell 29 obtained in step S24.

That is, in such a case, if the atmospheric temperature remains at a high temperature typically beyond the upper limit value Tlim, the high temperature control is conducted to cause the operating pressure to drop to a region to render the water balance to be minus in dependence on the operating load of the fuel cell 29, providing a capability for increasing the amount of steam to be exhausted outside the fuel cell system to preclude the temperature rise. Also, in alternative cases, such an operating pressure may be controlled using not only the pressure adjusting valves 63, 65 but also the compressor 25 or the combustor 37.

On the contrary, in step S12, if it is discriminated that the water tank water level drops to be equal to or lower than the lower limit value Lwlow, the operation proceeds to step S16.

In step S16, the map of FIG. 4 is referred to using the power output upper limit calculating section 101, retrieving the power output upper limit value Pwlim, which is the upper limit of the power output not to cause the water balance to become minus when the fuel cell 29 is operating at the operating pressure PO, in terms of the atmospheric temperature Tatm.

In succeeding step S18, the select-low circuit 102 is used, and either small one of the demanded power output PWd and the power output upper limit value Pwlim obtained in step S16 is selected whereupon the switch 103 is consecutively used and the power output PWg of the fuel cell 29 is determined at the value selected in step S18. That is, if the demanded power output PWd exceeds the power output upper limit value PWlim, then, the power output PWg is limited to be equal to the power output upper limit PWlim, whereas if the demanded power output PWd is equal to or below the power output upper limit value PWlim, the power output PWg is controlled to remain at the demanded power output PWd.

And, the operation proceeds to step S20 and to succeeding steps, sequentially executing the same operations as those of cases where, in step S12, discrimination is made for the water tank water level exceeding the lower limit value Lwlow.

That is, in such cases, the pressure upper limit value Pfclim of the fuel cell 29 is limited to a value in which the power output PWg of the fuel cell 29 is established without thermally affected troubles on the basis of the power output upper limit value PWlim and, thus, there is no probability in which the operating pressure of the fuel cell 29 is decreased to a lower value than the operating pressure PO that enables the water balance to be established, with a resultant improvement in the water balance. Further, in a case where the water level of the water tank does not remain in the low value but to exceed the reference value, the operating pressure is enabled to drop to the region in which the water balance falls in the minus range even when the atmospheric temperature remains at the high level. Accordingly, although the coolant water in the fuel cell is evaporated as steam which is exhausted outside the fuel cell system to gradually lower the water level of the water tank, it is possible for the fuel cell to be operated under a relatively high load even in a situation where the atmospheric temperature remains at the high level while effectively preventing the temperature rise of the fuel cell.

As set forth above, according to the presently filed embodiment, depletion of water is avoided without increasing the size of the coolant system of the fuel cell system, minimizing a probability in reduction of the power output as low as possible for thereby preventing the fuel cell from being operated at an excessively high temperature beyond the allowable limit value.

(Second Embodiment)

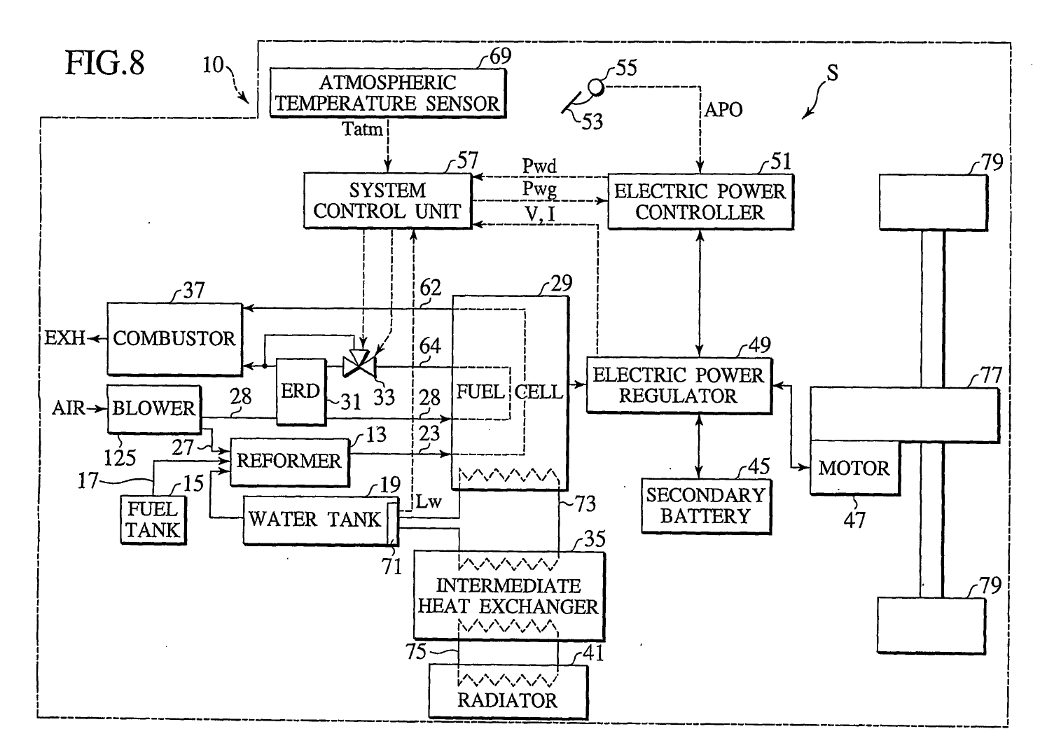

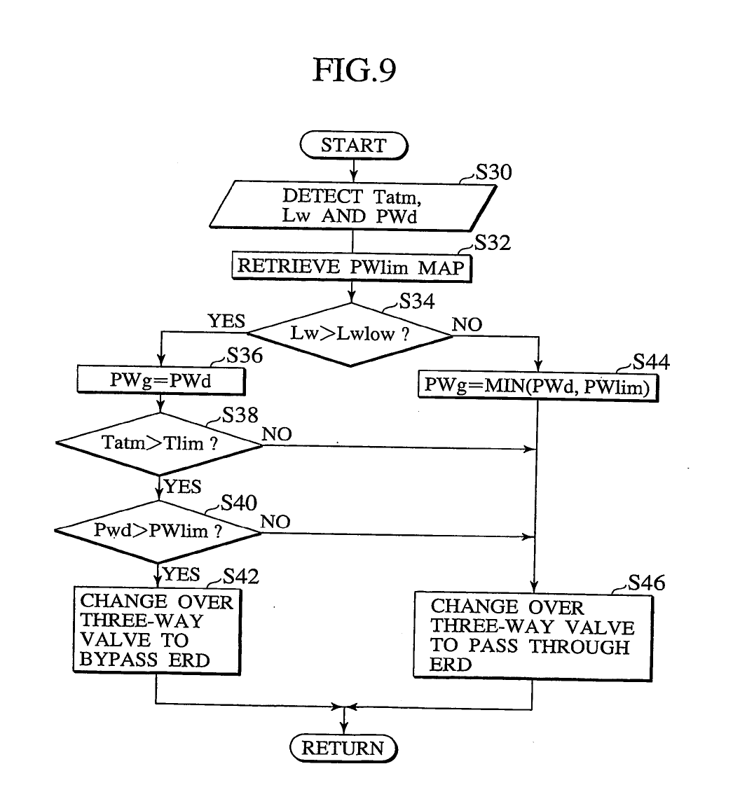

Now, a fuel cell system and a related method thereof of a second embodiment according to the present invention are described below in detail with reference to FIGS. 8 and 9.

FIG. 8 is an overall system structural view illustrating a structure of a fuel cell powered automobile 10 in which the fuel cell system S of the presently filed embodiment is installed. The second embodiment mainly differs in structure from the first embodiment in that an enthalpy exchange unit (hereinafter referred to as ERD) is employed, and is described below with like parts bearing the same reference numerals as those used in the first embodiment to suitably omit a redundant description.

In FIG. 8, the ERD 31 is disposed at an air intake side and exhaust side of air electrodes of the fuel cell 29.

The ERD 31 includes a humidity exchange type heat exchanger that provides heat exchange between the heat and humidity of the exhausts of the fuel cell 29 and the intake air. The exhaust air expelled from the fuel cell 29 is directed through the ERD 31 via an exhaust air line 64, and the exhaust air temperature is lowered, resulting in dehumidification. At the air intake side, air flowing from a blower 125 to the fuel cell 29 via the line 28 is directed to pass through the ERD 31 such that an intake air temperature is raised and is humidified.

That is, the provision of such an ERD 31 enables steam, which would be removed from the exhaust air, to be returned to the intake air, providing a capability for effectively collecting water whereby the fuel cell system can be operated in a further reliable manner so as to establish the water balance without reduction in water.

Further, a three-way valve 33 is disposed in the exhaust air line 64 of the fuel cell 29 at an inlet side of the ERD 31. Switching over such a three-way valve 33 enables air exhausted from the fuel cell 29 to be directly fed to the combustor 37 by bypassing the ERD 31. In a case where the air is bypassed in such a way, since no enthalpy exchange is implemented, the exhaust air expelled from the fuel cell 29 is exhausted while remaining at a high temperature and at a high humidity and, hence, air to be fed to the fuel cell 29 is not humidified and the temperature of intake air is not raised.

That is, even though the provision of the ERD 31 in combination with the three-way valve 33 enables reduction in the amount of water to be collected, the amount of steam to be removed from the exhaust air expelled from the fuel cell 29 increases with a resultant increase in the amount of steam to be exhausted outside the fuel cell system, correspondingly increasing the temperatures of the exhaust air and the exhaust humidity. Thus, the heat quantity to be left in the exhaust air increases and, to such extent, the heat quantity to be removed from the fuel cell 29 via the pure water channel 73 decreases, resulting in a decrease in the cooling load of the fuel cell 29 using the intermediate heat exchanger 35 and the radiator 41.

Now, the operation of the presently filed embodiment is described below with reference to FIG. 9 that illustrates the general flow diagram of the basic sequence of operations for controlling the fuel cell 29 with the use of the system control unit 57.

In FIG. 9, first in step S30, the atmospheric temperature Tatm, the water tank water level Lw and the demanded power output PWd are detected.

In the next step S32, upon establishment of the water balance in terms of the atmospheric temperature on the premise that the ERD 31 is used, the power output upper limit value PWlim to enable heat radiation is retrieved referring to the map of FIG. 4.

In succeeding step S34, discrimination is made as to whether the water tank water level Lw exceeds the lower limit value Lwlow. If the water tank water level Lw exceeds the lower limit value Lwlow, the operation proceeds to step S36 and if the water tank water level Lw is equal to or below the lower limit value Lwlow, then the operation proceeds to step S44.

That is, in step S34, if it is discriminated that the water tank water level Lw exceeds the lower limit value Lwlow, then in step S36, the power output PWg is determined to be equal to the same value as the demanded power output PWd and the operation proceeds to step S38.

Then in step S38, discrimination is made as to whether the atmospheric temperature Tatm exceeds the lower limit value Tlim. If the atmospheric temperature Tatm exceeds the lower limit value Tlim, i.e. when at the high temperature, the operation proceeds to step S40 to carry out the high temperature control and if the atmospheric temperature Tatm is equal to or below the lower limit value Tlim, the operation proceeds to step S46.

When, in step S38, if it is discriminated that the operating temperature remains at the high temperature, then in step S40, the power output PWg and the power output upper limit value PWlim are compared. If the power output PWg exceeds the output upper limit value PWlim, the operation proceeds to step S42, and if the power output PWg is equal to or below the output upper limit value PWlim, then, the operation proceeds to step S46.

When, in step S40, if it is discriminated that the power output exceeds the power output upper limit value PWlim, then in step S42, the three-way valve 33 is switched over to cause air expelled from the fuel cell 29 to bypass the ERD 31, i.e. to cause air not to pass through the ERD 31.

That is, in such a case, if the water tank water level exceeds a given level, it is possible for the fuel cell 29 to produce the maximum power output even under a condition in which the atmospheric temperature remains at a high level and the fuel cell 29 encounters a rigorous heat radiation.

On the contrary, if, in step S34, the water tank water level Lw is equal to or below the lower limit value Lwlow, the operation proceeds to step S44. In such step S44, the demanded power output PWd and the power output upper limit value PWlim are compared and the power output generated by the fuel cell 29 is determined to be equal to either small one of these variables, realizing the amount of power output limited to be equal to the power output PWg generated by the fuel cell 29 under the thermally established condition.

In succeeding step S 46, the three-way valve 33 is controlled such that air expelled from the fuel cell 29 passes without bypassing the ERD 31.

Further, although the water tank water level exceeds the lower limit value Lwlow, if, in step S38, it is discriminated that the atmospheric temperature Tatm is equal to or below the lower limit value Tlim, or if, in step S40, it is discriminated that the generated power output PWg is equal to or below the power output upper limit value PWlim, the operation proceeds to step S46 even in either instances, thereby controlling the three-way valve 33 to cause air expelled from the fuel cell 29 to pass without bypassing the ERD 31.

That is, in such instances where the water tank water level exceeds the given level and the atmospheric temperature exceeds the radiated heat limit value, the power output of the fuel cell 29 is limited by a required extent in a range that enables the water balance to be established, thereby precluding water from being depleted. In contrast, in a case where the atmospheric temperature does not remain at the high temperature and does not exceed the radiation heat limit value, water is collected in the usual practice and, thereafter, the maximum power output of the fuel cell is enhanced.

According to the presently filed embodiment, as set forth above, the radiator can be designed in a structure to have the irreducible minimum heat radiation capacity for a practical use, with a resultant reduction in size and weight of the radiator to provide an improved installation capability in the vehicle. Further, in contrast to the first embodiment, there is no need for the second embodiment to control the operating pressure of the fuel cell and instead the second embodiment is required to merely control the three-way valve. Thus, no consideration is required for a stability of the operating pressure, providing a capability of minimizing the degree of difficulty in control of the operating pressure to the lowest value.

(Third Embodiment)

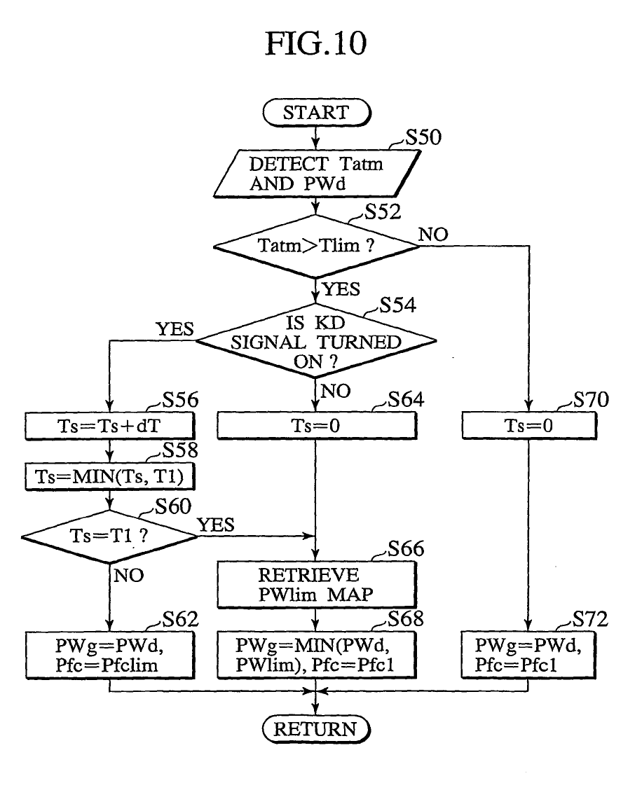

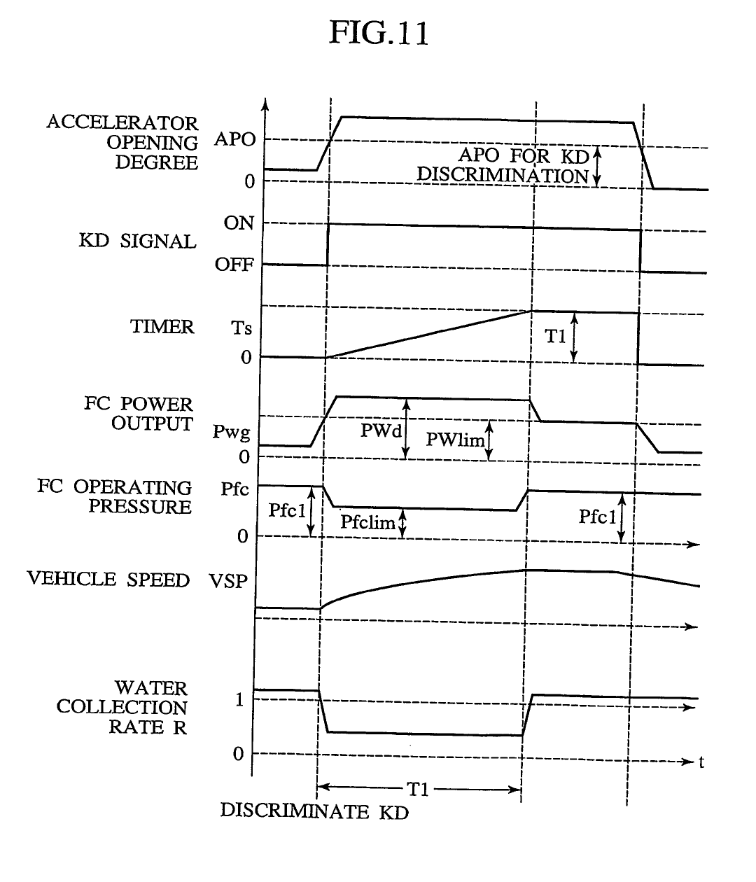

Now, a fuel cell system and a related method thereof of a third embodiment according to the present invention are described below in detail with reference to FIGS. 10 and 11.

Although the structure of the presently filed embodiment is identical to that of the first embodiment, a kick down signal KD generally indicative of a driver's acceleration will or intention and shown in FIG. 1 is incorporated for control in the system control unit 57. The presently filed embodiment is described below with like parts bearing the same reference numerals as those used in the first embodiment to suitably omit redundant description.

First, the operation of the presently filed embodiment is described with reference to FIG. 10 which shows a general flow diagram for illustrating the basic sequence of operations for controlling the fuel cell 29 using the system control unit 57. In addition, a timing chart for such control is illustrated in FIG. 11.

In the first instance, in step S50, the atmospheric temperature Tatm and the demanded power output PWd are detected.

In succeeding step S52, it is discriminated whether the atmospheric temperature Tatm exceeds the temperature limit value Tlim that enables the fuel cell to be operated to produce the rated power output under the operating pressure PO in which the water balance is established. If the atmospheric pressure Tatm is equal to or below the limit value Tlim, then, the operation proceeds to step S70 and if the atmospheric temperature Tatm exceeds the limit value Tlim, then, the operation proceeds to step S54.

That is, in step S52, when it is discriminated that the atmospheric temperature Tatm is equal to or below the limit value Tlim, then in step S70, a timer value Ts of a timer (not shown) located in the system control unit 57 is reset to a logic state of “0”.

In the next step S72, the power output PWg to be generated with the fuel cell 29 is determined to a value to be equal to the amount of demanded power output PWd. In addition, the operating pressure Pfc of the fuel cell 29 is set to the primary target value Pfcl depending on the water tank water level Lw.

On the contrary, in step S52, when it is discriminated that the atmospheric temperature Tatm remains at the high temperature which exceeds the limit value Tlim, then in step S54, discrimination is executed in dependence on varying rates between two accelerator opening degree signals APO, APO to find whether the KD signal, which is representative of the so-called kick down operation that is generally indicative of the driver's acceleration will or intention, remains in a turned “ON” state. And, in step S54, if discrimination is made that the KD signal remains in the turned “ON” state, the operation proceeds to step S56 and, in subsequent step S54, if discrimination is made that the KD signal remains in a turned “OFF” state, the operation proceeds to step S64. Also, when the accelerator opening degree signal APO rises at the varying rate equal to or higher than a given value, it may be assumed that the driver's acceleration will or intention is recognized and judgment may be made that the KD signal remains in the turned “ON” state. In addition, a variety of judgment standards may be utilized provided that these standards enable judgment for the requirement to increase the power output of the fuel cell 29 in dependence on the load of the fuel cell powered automobile.

That is, if it is discriminated that the KD signal remains in the turned “OFF” state in step S54, then in step S64, the timer Ts is reset to zero.

In the next step S66, the operation is executed referring to the map of FIG. 10 to retrieve the power output upper limit value PWlim, of the fuel cell 29 in terms of the atmospheric temperature Tatm, which enables the fuel cell 29 to operate under the operating pressure PO and to radiate heat while establishing the water balance.

In subsequent step S68, the power output PWg to be generated with the fuel cell 29 is determined to be equal to the smaller one between the PWd and PWlim. In addition, the operating pressure Pfc of the fuel cell 29 is determined to be equal to the pressure Pfcl depending on the water tank water level Lw.

On the contrary, further, if it is discriminated that the KD signal remains in the turned “ON” state in step S54, then in step S56, the timer Ts is renewed by adding a control cycle dT thereto.

In the next step S58, a comparison is executed between the timer value Ts and the given limit value T1 (ranging from several seconds to about 10 seconds), permitting either small one of these variables to be selected to be equal to the timer value Ts. That is, the timer value Ts is determined such that it does not exceeds the given limit value T1.

In subsequent step S60, discrimination is executed as to whether the timer value Ts is equal to the value T1 or is below the same. In step S60, if the discrimination is made on the presence of the timer value Ts equal to the given limit value T1, then, the operation proceeds to step S66 in which the fuel cell 29 is operated in a range to generate the limited power output while establishing the water balance. On the contrary, in step S60, if it is discriminated that the timer value Ts is not equal to the value T1, then, the operation proceeds to step S62.

That is, in step S60, if it is discriminated that the timer value Ts is not equal to the value T1, then in step S62, the power output PWg to be generated with the fuel cell 29 is determined to be equal to the power output PWd as demanded with no limit in the amount of power output to be generated. On the other hand, the operating pressure Pfc of the fuel cell 29 is determined to be equal to the pressure upper limit value Pfclim and controlled at a lower value than the pressure PO that establish the water balance.

Therefore, in such a case, a situation results in which the amount of water to be collected in the fuel cell decreases and the steam is exhausted outside the fuel cell system at an increased flow rate, with a resultant increase in the heat to be exhausted without troubles caused in the cooling condition to allow the maximum power output to be obtained even at the high temperature.

More particularly, the timing chart shown in FIG. 11 shows a diagram in which the accelerator is depressed under a condition where the atmospheric temperature Tatm is equal to or higher than the limit value Tlim and in which the accelerator is released after a time interval has elapsed beyond the limit value T1.

In FIG. 11, if the accelerator opening degree signal APO rises up at a varying rate beyond a given value, it is discriminated that the kick down takes place, and the KD signal is regarded to remain in the turned “ON” state. During a time interval T1, then the operating pressure Pfc of the fuel cell 29 is lowered from the value Pfcl to the lower limit value of Pfclim and the power output PWg is generated to meet the demanded power output PWd. After the time interval T1 has elapsed and in a subsequent stage, the operating pressure Pfc is returned to the value Pfcl and the water balance is established, whereupon the power output of the fuel cell 29 is lowered to the lower limit value of PWlim with no thermal issues. Also, in the figure, the vehicle speed of the fuel cell powered automobile 10 is shown at VSP, and the rate of water to be collected is indicated at R. Here, the water collection rate R refers to a value that is the product obtained by the amount of collected water divided by the amount of water that has been used.

As set forth above, in the embodiments according to the present invention, the power output can be ensured from the fuel cell at a rate necessary for obtaining the acceleration force to avoid the risks of hazardous situations even at the high atmospheric temperature without an increase in the size of the cooling system.

Further, since the demanded power output can be reliably enhanced for the time interval T1 (ranging from few seconds to about ten seconds) after the kick down has been initiated, the driver is able to perform the acceleration according to his intended feeling for such time interval after the accelerator has been depressed.

The entire content of a Patent Application No. TOKUGAN 2001-306237 with a filing date of Oct. 2, 2001 in Japan is hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

### INDUSTRIAL APPLICABILITY

As described above, according to the present invention, when the atmospheric temperature exceeds the given level, the high temperature control is executed so as to increase the amount of exhaust including steam to be expelled outside the fuel cell system, thereby precluding water from being depleted while preventing the occurrence of reduction in the power output as low as possible and preventing the temperature of the fuel cell from being excessively raised to the high temperature beyond the allowable limit without causing the cooling system of the fuel cell system from being largely sized. Consequently, the present invention is expected to have a wide application range covering the fuel cell powered automobile, using such a fuel cell system, domestic uses and industrial equipments.

1. A fuel cell system, comprising:
a fuel cell supplied with gas including hydrogen and gas including oxygen;
a humidifying mechanism humidifying either one or both of the gas including the hydrogen and the gas including the oxygen using water from a water tank;
a water collection mechanism collecting water from the fuel cell, the water collected by the water collection mechanism being returned to the water tank;
an atmospheric temperature sensor sensing an atmospheric temperature; and
a controller performing a high temperature control to increase an exhaust including steam to be expelled outside the fuel cell system when the atmospheric temperature sensed by the atmospheric temperature sensor exceeds a given temperature.

2. The fuel cell system according to claim 1, further comprising a cooling mechanism cooling the fuel cell,
wherein the given temperature of the atmospheric temperature corresponds to a temperature in which a radiation heat quantity necessary for ensuring power output demanded to the fuel cell exceeds a radiation heat quantity of the cooling mechanism.

3. The fuel cell system according to claim 2, wherein the humidifying mechanism, the water collection mechanism and the cooling mechanism include a common water channel.

4. The fuel cell system according to claim 2, wherein the cooling mechanism is operative to execute a heat exchange between water to be supplied to the fuel cell and an anti freeze solution.

5. The fuel cell system according to claim 1, further comprising a water level detector detecting a water level of the water tank,
wherein the controller is operative to execute the high temperature control in dependence on the water level of the water tank detected by the water level detector.

6. The fuel cell system according to claim 5, wherein the controller is operative to execute the high temperature control when the water level of the water tank detected by the water level detector exceeds a given lower limit value.

7. The fuel cell system according to claim 1, wherein the controller is operative to execute the high temperature control for a given time interval after a power output of the fuel cell is demanded.

8. The fuel cell system according to claim 7, wherein the fuel cell system is applied to a vehicle, and the controller executes the high temperature control for the given time interval in dependence on a load of the vehicle.

9. The fuel cell system according to claim 1, wherein the high temperature control permits an operating pressure of the fuel cell to be lowered.

10. The fuel cell system according to claim 1, wherein the water collection mechanism includes a water channel disposed in the vicinity of an air electrode of the fuel cell, and the high temperature control permits a supplying pressure of the air to the air electrode of the fuel cell to be lowered.

11. The fuel cell system according to claim 1, wherein the water collection mechanism includes a humidity exchange type heat exchanger performing exchange in temperature and humidity between an exhaust air from an air electrode of the fuel cell and an intake air supplied to the air electrode.

12. The fuel cell system according to claim 11, wherein the high temperature control permits the exhaust air expelled from the air electrode or the intake air supplied to the air electrode to bypass the humidity exchange type heat exchanger to compel the exhaust air to be expelled outside the fuel cell system or the intake air to be supplied to the fuel cell.

13. The fuel cell system according to claim 1, wherein the controller is operative to control the power output of the fuel cell in dependence on the atmospheric temperature sensed by the atmospheric temperature sensor.

14. The fuel cell system according to claim 13, wherein the controller is operative to limit the power output of the fuel cell when the atmospheric temperature exceeds the given temperature.

15. A fuel cell system, comprising:
a fuel cell supplied with gas including hydrogen and gas including oxygen;
humidifying means for humidifying either one or both of the gas including the hydrogen and the gas including the oxygen using water from a water tank;
water collection means for collecting water from the fuel cell, the water collected by the water collection means being returned to the water tank;
atmospheric temperature sensing means for sensing an atmospheric temperature; and
control means for performing a high temperature control to increase an exhaust including steam to be expelled outside the fuel cell system when the atmospheric temperature sensed by the atmospheric temperature detection means exceeds a given temperature.

16. A method of controlling a fuel cell system, comprising:
supplying gas including hydrogen and gas including oxygen to a fuel cell;
humidifying either one or both of the gas including the hydrogen and the gas including the oxygen using water from a water tank;
collecting water from the fuel cell to circulate the collected water to the water tank;
sensing an atmospheric temperature; and
performing a high temperature control to increase an exhaust including steam to be expelled outside the fuel cell system when a sensed atmospheric temperature exceeds a given temperature.
